(19) United States
(12) Patent Application Publication
(10) Pub. No.: US 2011/0197865 A1
(43) Pub. Date: Aug. 18, 2011

(54) INTENTIONAL ARCING OF A CORONA IGNITER

(76) Inventor: Keith Hampton, Ann Arbor, MI (US)

(21) Appl. No.: 13/025,816

(22) Filed: Feb. 11, 2011

Related U.S. Application Data
(60) Provisional application No. 61/304,130, filed on Feb. 12, 2010.

(51) Int. Cl. F02P 3/04; H05H 1/36

(52) U.S. Cl. 123/623; 315/120

(57) ABSTRACT

A corona ignition system and method for igniting combustible gaseous mixtures includes the detection and control of arcing such that when arcing occurs, it is detected and the voltage to the ignitor increased to ensure sustained arcing for a period of time and of such quality that combustion of the mixture occurs through spark ignition for a period of time, after which the voltage is decreased to restore ignition by corona discharge only.

### CLAIM FOR PRIORITY

This invention claims the benefit of priority to U.S. Provisional Application No. 61/304,130 filed Feb. 12, 2010, the entire contents of which are hereby incorporated by reference.

### TECHNICAL FIELD

This invention relates generally to a corona discharge ignitor used to ignite air/fuel mixtures in automotive application and the like, and in particular to a system and method that detects arcing in a corona discharge ignitor and intentionally causes the igniter to arc.

### RELATED ART

U.S. Pat. No. 6,883,507 discloses an ignitor for use in a corona discharge air/fuel ignition system. FIG. 1 shows components of an exemplary corona discharge ignition system. The ignition system includes a low voltage circuit 10 coupled across a radio frequency step-up transformer 20 to a high voltage circuit 30, which in turn is coupled to an electrode 40 which is inside the combustion chamber 50.

In a corona ignition system, a radio frequency high voltage signal is applied to the electrode 40 that is positioned in the combustion chamber 50, as described above. When this signal is applied, an electric field is created in the combustion chamber 50. The field is intense enough to greatly increase the number of ions in the chamber. Under specific conditions the ions can form a conductive path from the electrode to the cylinder head or piston. If the voltage is high enough the current flowing in this path will heat the path enough to form still more ions. This can become a cascading process that results in an arc being established. This arc will heat up the electrode 40. At the same time, an arc discharge is less effective at igniting the fuel in the chamber than a corona discharge is. Therefore, suppression of arc is required. There are several traditional methods used to suppress arc and ensure ignition. Suppressing the formation of arc requires measurement of the impedance to ground of the circuit, and adjustment of the voltage accordingly

FIG. 2 shows a flow diagram of suppressing arc formation according to the prior art. As illustrated, corona is initiated (200) and the system monitors the state of the corona. In the event corona remains (202), the DC voltage is maintained at the RF transformer (204), and ignition is likely to be a success (206). If, on the other hand, corona begins to form an are (208), the DC voltage at the RF transformer is reduced to try and prevent the arc from forming any further (210).

### SUMMARY OF THE INVENTION

In general terms, this invention provides a corona discharge ignitor system and method used to ignite air/fuel mixtures in automotive furnace and other applications were combustible mixtures are to be ignited, and in particular to a system and method in which, when arcing is detected in a corona discharge ignitor, adjustments are made to intentionally enhance the arcing for a period of time.

The invention detects arcing by one of several methods including (1) an abrupt change in current to the inductor, (2) an abrupt change in voltage to the inductor, (3) an abrupt change in frequency of resonance of the inductor, (4) an abrupt change in the computed corona cloud resistance, and (5) a detection of misfire by ionization detection, and crankshaft speed change. It is appreciated that the detection methods are not limited to the disclosed methods, and that any number of detection methods may be used, as readily understood by the skilled artisan.

In one embodiment of the invention, upon detection of an arc during a corona event, voltage to a circuit is increased to ensure that arcing occurs. This increase in voltage provides the maximum voltage to the igniter connected to the combustion chamber. The voltage value that is determined to be applied to the circuit for subsequent ignition events is simultaneously reduced by a predetermined amount, and recorded to memory. A software or control program (e.g. an algorithm), operating in the ignition controller software along with the electronic hardware to detect arcing, later tests the revised recorded value.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 shows components of an exemplary corona discharge ignition system in accordance with the prior art.

FIG. 2 shows a flow diagram of suppressing arc formation according to the prior art.

FIGS. 3, 4 and 5 illustrate an exemplary circuit diagram of the corona ignition circuit in accordance with the invention.

FIG. 6 shows a flow diagram of a intentional arcing method in accordance with the invention.

FIG. 7 shows a high-level exemplary flow diagram of a control program in accordance with the invention.

FIG. 8 illustrates an exemplary look up table of the general type that may be used by the control program to calculate a reduced voltage for an ignition event.

FIG. 9 is a detailed exemplary flow diagram of a control program in accordance with the invention.

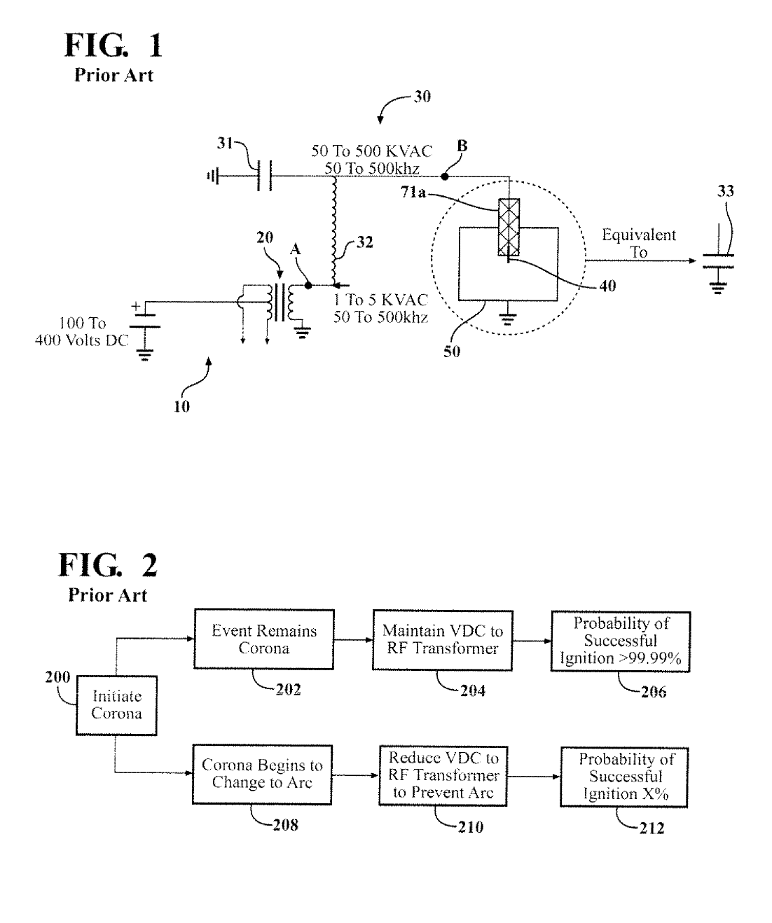

### DETAILED DESCRIPTION OF A PREFERRED EMBODIMENT

In a corona ignition system, a radio frequency signal is generated in an electronic circuit and transmitted through a coaxial cable to an ignitor. If the voltage is too high, then an unwanted arc can form from the electrode tip to the head. In one known corona system described in the background of the invention, a complex control system is employed to actively measure and monitor impedance in order to prevent arcing and failure of ignition. However, it has been found that it is not always possible to suppress arcing while attempting to initiate a corona event, in which case it is preferable to ensure that the arc energy is maximized for proper ignition for a period of time. The corona ignition system according to one aspect of the invention monitors a corona event, and when arcing occurs adjustments are made to increase voltage to the circuit in order to maximize arcing and the quality of the arcing for a given period of time, thereby providing the highest probability of a successful ignition.

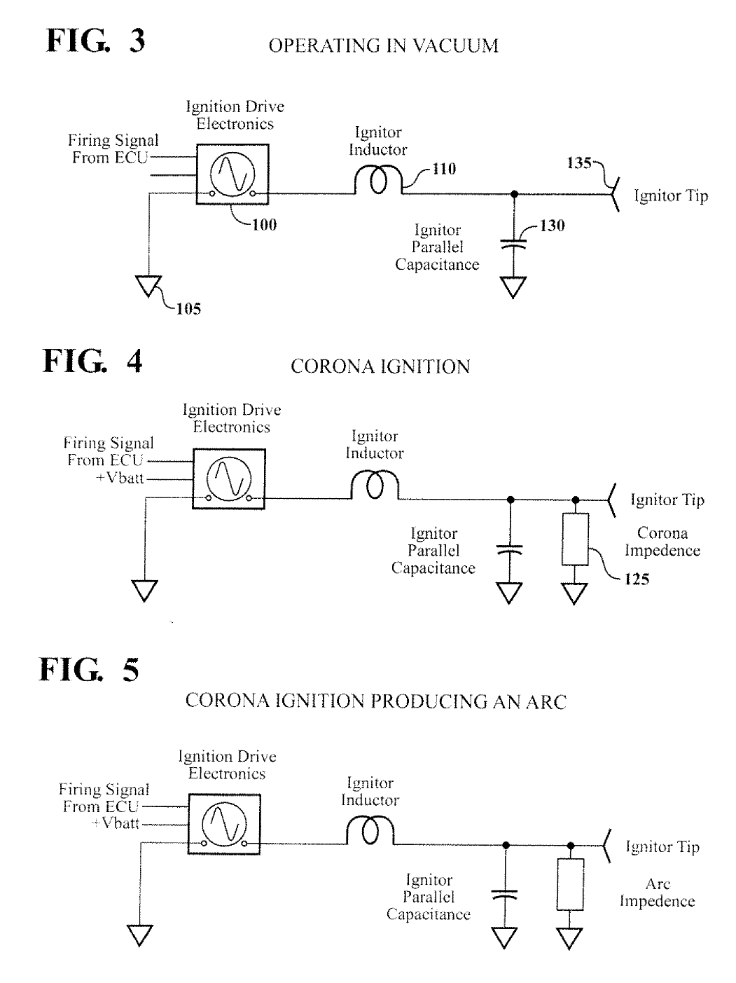

FIGS. 3-5 illustrate circuit diagrams of an exemplary corona ignition circuit in accordance with an embodiment the invention. In the drawings, similar reference numerals represent similar components. The circuit includes ground 105, ignition drive electronics 100, ignitor inductor 110, resistance between the igniter tip to ground through the combustion chamber gasses 125, ignitor parallel capacitance 130 and ignitor tip 135. The ignitor tip 135 is part of an ignitor and in particular coupled to a single center electrode and may be mounted within an ignitor bore of a cylinder head which is joined to an engine block of an internal combustion engine. There is no second electrode per se, such that the corona generated is produced at the ignitor tip and not in a gap between two electrodes as in some plasma jet type ignition systems. The engine block includes a combustion cylinder in which a piston reciprocates. The engine may have a plurality of such combustion cylinders and associated pistons (not shown).

The circuit is driven by ignition drive electronics 100, such as a power amplifier, which receives a firing signal from an external engine computer (not shown). The ignition drive electronics 100 outputs a voltage that is applied at a natural frequency to the ignitor inductor 110. The ignitor inductor 110 multiplies the input voltage to a high voltage that is applied to the ignitor tip.

In operation, the drive electronics generates an alternating voltage that is applied to the inductor. The inductance, resistance, and capacitance, LRC, has a natural frequency, and if the applied alternating voltage includes a component at the LRC natural frequency, then the inductor voltage at the igniter tip will be a multiple of the applied voltage. FIG. 3 shows such a circuit operating in a vacuum. In FIG. 4, which shows the system of FIG. 3 with the igniter tip placed in a combustion chamber during a corona event, gasses that exist inside the chamber, especially at the point of ignition, have a resistance to electrical current. When the drive voltage is applied to the inductor, a corona will form at the igniter tip. This region of ionized gas has a further reduced resistance. In addition some current may flow from the firing end to ground.

When the density of ions between the ignitor tip and the cylinder head exceeds a certain value, the resistance of this region drops to a level that a current can flow directly from the igniter tip to ground. This is a cascade phenomena in that once current flow exceeds a certain value, this heats the gas, increasing the number of ions, which reduces resistance further. During this cascade, the temperature of the ionized region raises and forms an arc (FIG. 5). The high temperature of the arc can damage the igniter tip, and does an inferior job of igniting the mixture.

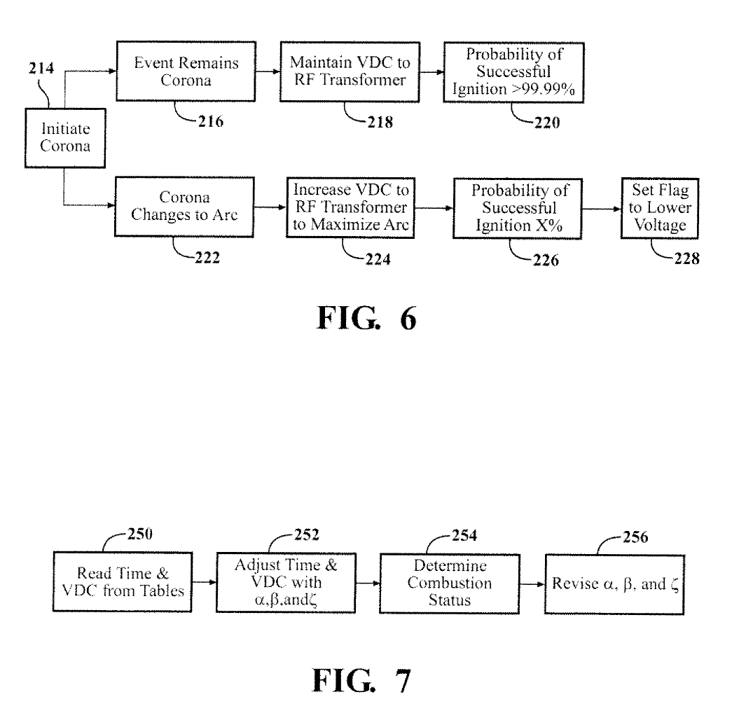

Certain events, such as cold weather or poor operating conditions, will affect operation such that corona does not occur or an arc will not be suppressed. When this occurs, the invention seeks to maximize the likelihood and quality of an arc to create ignition, as illustrated in FIG. 6. FIG. 6 shows a flow diagram of a intentional arcing method in accordance with the invention. As illustrated, corona is initiated (214) and the system monitors the state of the corona. In the event corona remains (216), a DC voltage is maintained at an RF transformer (218) of the system, and ignition is likely to be a success (220). If, on the other hand, the corona transforms into an arc (222), the DC voltage at the RF transformer is increased to force an arc (224) to be maintained. That is, upon detection of an arc during a corona event, voltage to the circuit is increased to ensure that arcing occurs and at a level that maximizes the probability of ignition (226). The voltage value that is determined to be applied to the circuit for subsequent ignition events is simultaneously reduced by a predetermined amount in order to switch back to only corona ignition, recorded to memory, and a flag is set (228). A software or control program (e.g. an algorithm), operating in the ignition controller software along with the electronic hardware to detect arcing, later tests the revised recorded value.

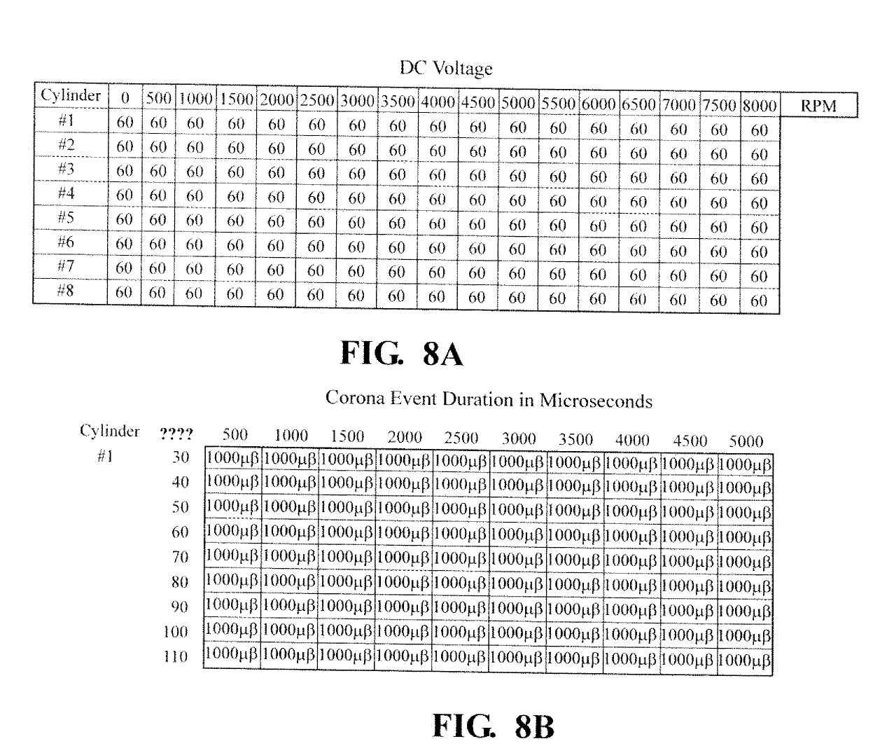

FIG. 7 shows a high-level exemplary flow diagram of a control program in accordance with the invention. The control program (or learning algorithm) initially reads the corona duration time and DC voltage from tables stored in memory (25). An exemplary table is illustrated in FIG. 8, which stores voltage, corona duration time and cylinder information. The time and DC voltage are adjusted with α, β, and ζ (252), the combustion status is determined (254) and the α, β, and ζ are revised (256), as provided in more detail below.

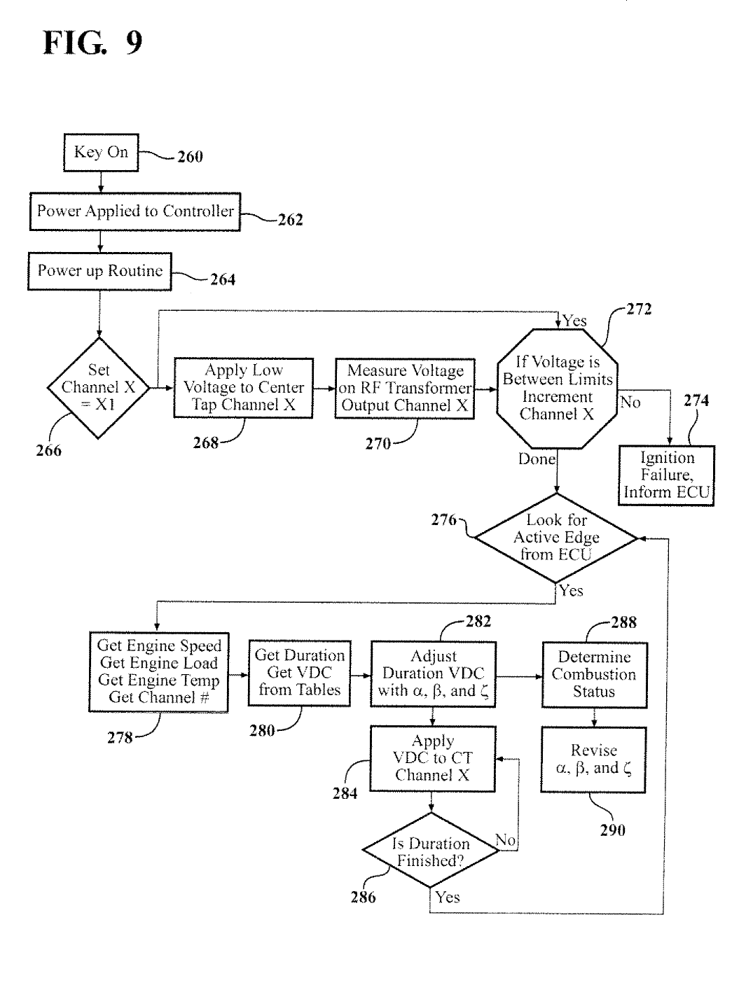

FIG. 9 is a detailed exemplary flow diagram of a control program in accordance with the invention. Upon turning on the ignition (key on) of a vehicle (260), power is applied to an electronic circuit, which includes a controller (262), and the control program is powered up (264). In operation, the control program determines whether the set channel X equals X1 (266). If channel X is set to X1, then the control program proceeds to determine whether the voltage applied is between specified limits, and increments channel X (272). If channel X is not set to X1, a low DC voltage (VDC) is applied to the center tap channel X (268), and the voltage on the RF transformer's output channel X is measured (270). The control program then proceeds to determine whether the voltage is between specified limits, and increments channel X (272). If the measured voltage is not between specified limits, then there is an ignition failure, and the engine control unit (ECU) is notified (274). If, on the other hand, the measured voltage is between the specified limits, the control program monitors the incoming signal from the ECU for an active edge (276). Once an active edge is detected, the control program acquires the engine speed, load, temperature and channel number (collectively, engine information) at (278). Upon acquisition of the engine information, the stored tables generically shown in (FIG. 8) are accessed to obtain the duration and DC voltage that correspond to the engine information (280). The duration and DC voltage are then adjusted with α, β, and ζ (282). After adjusting the duration and DC voltage, the DC voltage is applied to the center tap channel X (284), and the control program determines whether the duration is finished (286). If not, the DC voltage is reapplied. If the duration is finished, then the control program cycles back to determine whether there is an active edge on the signal from the ECU. In parallel, after adjusting the duration and DC voltage, the control program determines the combustion states, (288) and revises α, β, and ζ (290). The revised calculations are then used during the next cycle

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A method of detecting an arc during a corona event such that when the are is detected, intentionally forcing the arc by increasing a voltage to an RF transformer.

2. The method of claim 1, wherein the voltage increase is forced during a current cycle, and the voltage is decreased during a subsequent cycle.

3. The method of claim 2, wherein the increase and decrease of voltage is based on a table based mapping approach.

4. The method of claim 3, wherein the table is adapted according to the arc event.

5. The method of claim 1, wherein once the corona event is initiated, maintaining the voltage to the RF transformer.

6. The method of claim 5, further comprising:
reading time and voltage from the table;
adjusting the time and voltage using parameters;
determining a combustion status; and
revising the parameters.

7. A method of igniting a combustible gaseous mixture within a combustion chamber, comprising
applying voltage to an igniter to generate a corona discharge from the igniter without the formation of an arc to thereby ignite the combustible mixture within the chamber with the corona discharge for a first period of time;
changing a condition such that a dielectric breakdown of the corona occurs and arcing occurs from the igniter;
detecting the occurrence of the arcing event; and
increasing the voltage applied to the ignitor to produce additional arcing events for a second period of ignition cycles to ignite the mixture by spark ignition during such second period.

8. The method of clam 7 wherein following the second period of ignition by arcing, reducing the applied voltage to a level that restores corona discharge without arcing to continue igniting the mixture by corona discharge ignition.

9. A computer program product stored on a tangible medium, executable on a microprocessor of a vehicle having an electronic control unit, comprising: detecting an arc during a corona event such that when the arc is detected, intentionally forcing the arc by increasing a voltage to an RF transformer.

10. The computer program product of claim 9, further comprising:
setting a channel and applying a low voltage;
measuring voltage on a transformer;
if the voltage is between predetermined limits, increment the channel and determine whether an active edge has been detected from the electronic control unit;
gathering engine parameters.

11. The computer program product of claim 9, further comprising:
reading time and voltage from the table;
adjusting the time and voltage using parameters;
determining a combustion status
applying voltage; and
revising the parameters.

12. The computer program product of claim 7, wherein the engine parameters include speed, load, temperature and channel number.
